(19) United States
(12) Patent Application Publication
(10) Pub. No.: US 2020/0178471 A1
(43) Pub. Date: Jun. 11, 2020

(54) Twine Shifter Assembly for Hay Baler

(71) Applicant: GFC, Pittsfield, IL (US)

(72) Inventors: Owen J. Brown, JR., Pittsfield, IL (US); Bensend Thompson, Louisiana, MO (US)

(73) Assignee: GFC, Pittsfield, IL (US)

(21) Appl. No.: 16/790,718

(22) Filed: Feb. 13, 2020

Related U.S. Application Data
(63) Continuation-in-part of application No. 16/175,780, filed on Oct. 30, 2018.
(60) Provisional application No. 62/804,811, filed on Feb. 13, 2019.
(60) Provisional application No. 62/804,812, filed on Feb. 13, 2019.

(51) Int. Cl. A01F 15/14

(52) U.S. Cl. CPC A01F 15/145

(57) ABSTRACT

Twine shifters that enable the mechanical knotter of a hay baler to tie either two twines into a 2-twine knot or tie four twines into a 4-twine knot. For a 2-twine knot the twine shifters each move their respective upper and lower twines out of the needle's path where the twines are gathered to be tied in a knot. So when the needle swings through its path it only picks up two strands, and misses the two strands moved out of its path. To tie a 4-twine knot the upper and lower twine shifters each move their respective upper and lower twines back into the needle's path. This allows the needle to gather up all four twine strands to tie in a 4-twine knot.

### CROSS-REFERENCE TO RELATED APPLICATIONS

The present application claims priority from, and incorporates by reference in its entirety, provisional U.S. patent application 62/804,811 filed Feb. 13, 2019.

The present application claims priority from, and incorporates by reference in its entirety, U.S. patent application Ser. No. 16/175,780 filed Oct. 30, 2018.

The present application claims priority from, and incorporates by reference in its entirety, provisional U.S. patent application 62/804,812 filed Feb. 13, 2019.

### BACKGROUND

### Technical Field

Various embodiments of the present invention relate to balers for collecting and baling hay or other crops. More particularly, the present invention pertains to components of a knotter for tying and knotting twines around one or more bales.

### Description of Related Art

To secure bales of fibrous material such as hay, twine is often wrapped around the bale and tied to create a hay bale. A crucial part of any hay baler is the mechanical knotter that ties knots in the twine during the baling process. Mechanical knotters are an incredibly complex piece of machinery. Conventional knotters tie knots in two strands of twine—that is, 2-twine knots.

### BRIEF SUMMARY

Various embodiments disclosed herein are drawn to a twine shifter assembly that is configured for use with a multi-part square hay baler. The baler includes a needle component that is capable of moving up to a mechanical knotter and down below the bale. The needle moves within in a needle plane. The baler has an upper twine shifter assembly and a lower twine shifter assembly. The twine shifter assemblies respectively include an upper twine guide and a lower twine guide. The twine guides are aligned within the needle plane in a rest position and are outside of the needle plane in a shifted position.

The upper twine shifter assembly also includes an upper actuator cylinder affixed to the upper twine guide. The lower twine shifter assembly has a lower actuator cylinder affixed to the lower twine guide. The actuator cylinders are configured to controllably move the upper and lower twine guides between the resting position and the shifted position, thus moving the upper twine into or out of the needle plane for selectively tying a 4-strand knot or a 2-strand knot.

### BRIEF DESCRIPTION OF THE DRAWING

The accompanying drawing, which is incorporated in and constitutes part of the specification, illustrates various embodiments of the invention. Together with the general description, the drawings serve to explain the principles of various embodiments of the invention. In the drawings:

FIG. 1 is an oblique cutaway view of a multi-part square baler depicting the needle lowered below the lower twine shifter in the resting position, according to various embodiments.

FIG. 2 is an oblique cutaway view of a multi-part square baler depicting the needle moved to an upward position while the lower shifter remains in the resting position.

FIG. 3 is an oblique cutaway view of a multi-part square baler depicting the needle lowered below the level of the lower twine, while the lower shifter is actuated.

FIG. 4 is an oblique cutaway view of a multi-part square baler depicting the needle moved upward past the level of the lower twine, while the lower shifter is actuated.

FIG. 5 is an oblique cutaway view of a multi-part square baler depicting the needle positioned directly below the upper twine, while the upper shifter is in the resting position.

FIG. 6 is an oblique cutaway view of a multi-part square baler depicting the needle moved upward carrying the upper twine with it, while the upper shifter remains in the resting position.

FIG. 7 is an oblique cutaway view of a multi-part square baler depicting the needle below the level of the upper twine, while the upper shifter is actuated.

FIG. 8 is an oblique cutaway view of a multi-part square baler depicting the needle moved upward past the upper twine, while the upper shifter is actuated.

FIG. 9 depicts internal mechanisms of a multi-part square baler suitable for use with various embodiments disclosed herein.

FIG. 10 depicts a flowchart of a method for using various embodiments disclosed herein.

### DESCRIPTION

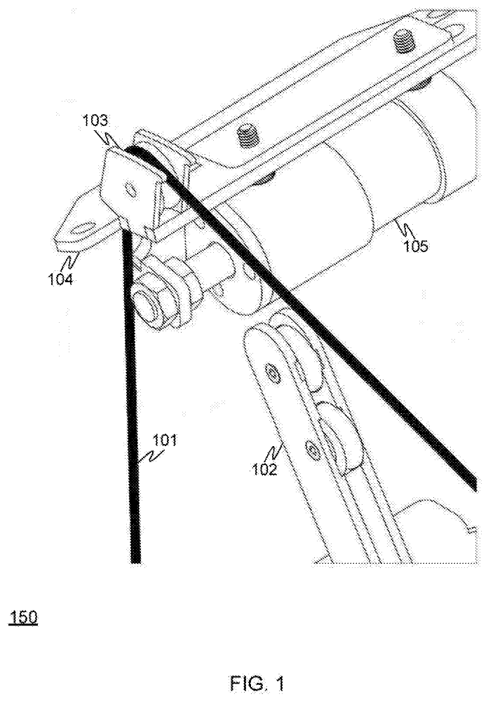

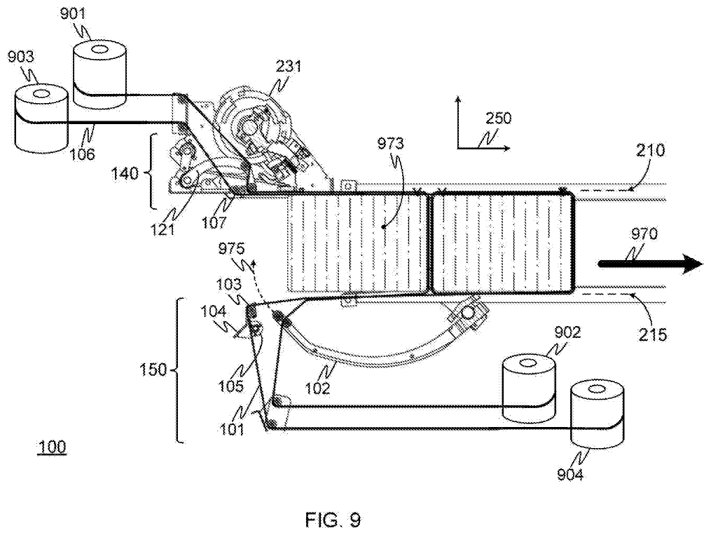

FIG. 1 depicts needle 102 lowered below the lower twine shifter assembly 150 which is in the resting position, according to various embodiments. The figure shows components of a lower shifter assembly 150 for use with a double knotter 231, according to various embodiments. The components depicted in FIG. 1 are part of a multi-part square baler 100 with a double knotter 231, as depicted in FIG. 9. The present inventors work for the company where the multi-part square baler was invented. The multi-part square baler 100 bales multiple small single bales into a large multi-part bale. U.S. patent application Ser. No. 16/175,780 entitled “High Density Double Small Square Baler”—owned by the same assignee as the present patent application-discloses the multi-part square baler 100.

The double knotter 231 of the multi-part square baler 100 is capable of tying two twines together in a 2-twine knot, and is also capable of tying four twines together in a 4-twine knot. Conventional knotters only tie knots in two strands of twine—that is, only 2-twine knots. No known conventional knotter is used to tie 4-strand knots. Thus, no conventional knotter is reliably capable of tying both 2-twine knots and 4-twine knots. In fact, prior to the present inventors' research and development efforts there wasn't a recognized need in the art to tie both 2-twine knots and 4-twine knots using the same knotter.

Turning to FIG. 9, in order for double knotter 231 to be able to tie both 2-twine and 4-twine knots the assembly must be capable of selectively moving two twines into, or out of, the path of needle 102. A 4-twine knot ties twines from each of the four spools 901-904. A 2-twine knot ties twines only from spools 901 and 902. The double knotter 231 ties a knot in the twines that are fed to it. If four twines are fed to it, the double knotter 231 ties a 4-twine knot. If only two twines are fed to it, the double knotter 231 ties a 2-twine knot. The needle 102 acts to feed twines into double knotter 231. The needle 102 is controlled to rotate about point 973 so as to move in direction 975. The needle 102 rotates in a plane of motion that is referred to herein as needle plane 250. The needle plane 250 is defined by the pair of intersecting perpendicular lines 250 shown in FIG. 9. One of the lines defining needle plane 250 is in the direction of bale movement 970 and the other line is in the upward direction. The axis of rotation of needle 102 is parallel to the axis of rotation of double knotter 231.

When all four twines are held taut within needle plane 250 the needle 102 hinges upward, gathering the four twines, and feeds them into knotter 231 to tie a 4-twine knot. To tie a 2-twine knot the twines 101 and 106 are shifted out of needle plane 250 and held to the side while needle 102 rotates upward. In this way, needle 102 only gathers the two remaining twines (from spools 901 and 902) to feed into knotter 231 which ties them into a 2-twine knot.

The multi-part square baler 100 shown in FIG. 9 has an upper twine shifter assembly 140, including a tucker arm 121, and a lower twine shifter assembly 150. The upper and lower twine shifter assemblies 140/150 are the mechanisms used to move the strands of twine into and out of the needle plane 250 during the process of tying the different knots in a multi-part square bale. In working to improve the various versions of the multi-part square balers and perfecting the operation of the components the present inventors recognized a need for improved shifter mechanisms used by knotter 231 to be able to tie both 2-twine and 4-twine knots.

FIGS. 1-8 illustrate the motions of the upper twine shifter assembly 140, the lower twine shifter assembly 150, and the needle 102 during the knotting process by showing the components in eight different positions. The upper twine shifter assembly 140 and the lower twine shifter assembly 150 are both capable of being in either a resting position (non-shifted) or in a shifted position. The two shifter assemblies 140/150 achieve these two positions in slightly different manners.

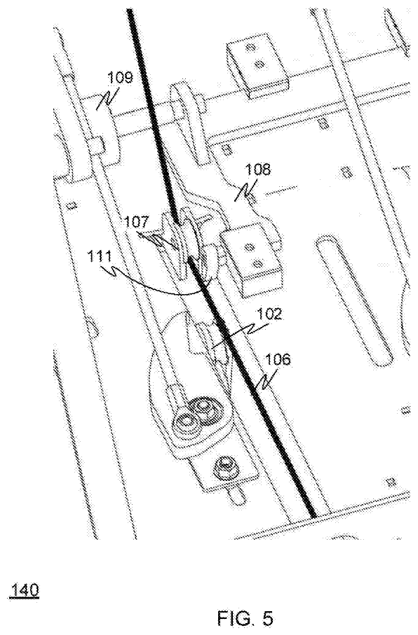

FIGS. 1-4 show lower twine shifter assembly 150 in four different positions. The various embodiments of lower twine shifter assembly 150 shown in FIGS. 1-4 have a number of components, including a lower twine strand 101, a needle 102, lower twine shifting guide roller 103, a base bracket 104 and a lower actuator cylinder 105. FIGS. 5-8 show the upper twine shifter assembly 140 in four different positions. The various embodiments of the upper twine shifter assembly 140 shown in FIGS. 5-8 have a number of components, including an upper twine strand 106, an upper twine guide roller 107, an upper shifting carriage 108, and an upper actuator cylinder 109.

In some embodiments the lower actuator cylinder 105 of FIGS. FIGS. 1-4 and the upper actuator cylinder 109 of FIGS. FIGS. 5-8 are hydraulic cylinders powered by the same hydraulic system as the multi-part square baler 100 itself. However, in various other embodiments the lower and upper actuator cylinders 105/109 can be implemented with pneumatic cylinders, electric motors, mechanical linkages or any other equivalent types of powering a push/pull mechanism known to those of ordinary skill in the art.

FIGS. 1-9 depict twine guides in the form of lower twine shifting guide roller 103 and the upper twine guide roller 107. In some embodiments actual mechanical rollers are used as shown in the figures. However, various other embodiments may use polished steel trough guides, mechanical fingers, multi-roller guides or any other type of twine guide known to those of ordinary skill in the art. The lower twine shifting roller 103 is depicted in FIGS. 1-4 as being connected to base bracket 104. The base bracket 104, in turn, is slidably connected to lower actuator cylinder 105. As such, the lower twine shifting roller 103 can be said to be connected to lower actuator cylinder 105 via the base bracket 104. Similarly upper twine guide 107 is affixed to the same bracket as upper actuator cylinder 109, and is therefore said to be connected to upper actuator cylinder 109 via the bracket.

Turning to FIG. 1, the needle 102 is shown in its lowered position, and the lower twine shifter assembly 150 is shown in its resting position, according to various embodiments. The resting position of the lower twine shifter assembly 150 is the non-shifted position—that is, the lower twine shifter assembly 150 has not moved lower twine 101 out of needle plane 250. As such, the lower twine 101 is being held directly over the needle 102 so that as needle 102 swings upward it will catch lower twine 101 and carry it up into the knotting mechanism 231. The lowered position of needle 102 shown in FIG. 1 is at the needle 102's lowest point—or at least a point where the needle 102 is below lower twine 101, for example, as shown in FIG. 1 and FIG. 9.

At this stage, before needle 102 pushes upward, the lower twine 101 is held taut in a vertical position called the lower bale surface position 215. The upper bale surface position 210 and lower bale surface position 215 are approximately planar with the respective top and bottom surfaces of the bales being formed, as shown in FIG. 9. In practice, the upper twine 106 may be angled slightly upward relative to the bale's upper surface and the lower twine 101 may be angled slightly downward relative to the bale's lower surface in order to create a twine opening for the hay of the bale to be pushed into (so the hay doesn't bind up or catch on the twine as is pushes the four twines through the baler chute). However, to simplify the explanation the positioning of twine 106 and twine 101, the two twines are referred to herein as respectively being in the upper bale surface position 205 and the lower bale surface position 215. If the twines 106 and 101 are shifted to the side and the needle 102 passes by them as it rotates upward, the twine 106 will remain within the upper bale surface position 205, and twine 101 will remain in the lower bale surface position 215.

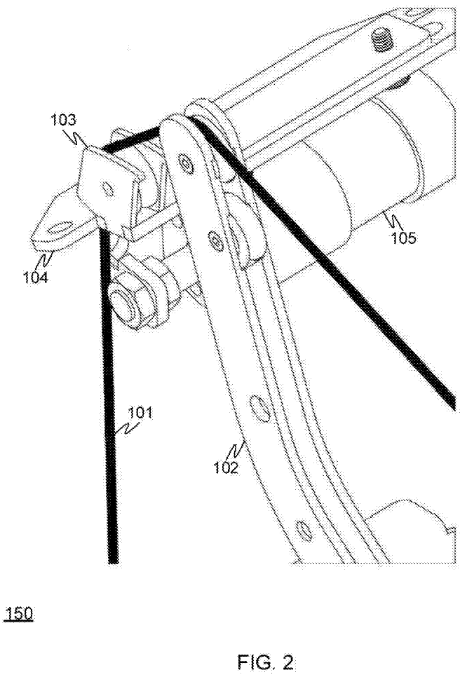

FIG. 2 depicts the needle 102 moved towards an upward position while the lower shifter assembly 150 remains in the resting position (non-shifted). This allows the needle 102 to pick up lower twine 101 as it rotates past lower twine shifting guide roller 103. In the resting (non-shifted) position the lower twine shifting guide roller 103, the lower twine 101 and the needle 102 are all in needle plane 250. As needle 102 continues to rotate upward it gathers the long bottom twine from spool 902 and continues upward towards the knotter 231.

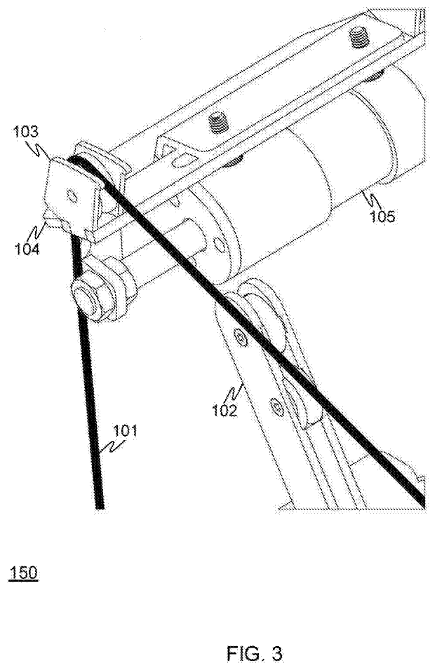

FIG. 3 depicts the needle 102 in a lowered position below the horizontal level of the lower twine 101, while the lower twine 101 is at the same horizontal level as the lower bale surface position 215. In this figure the lower shifter assembly 150 has been actuated to move lower twine 101 out of the needle plane 250. It should be noted that needle 102 always remains within needle plane 250—at its lowered position, at its highest position up towards the knotter 231, and at all points in between.

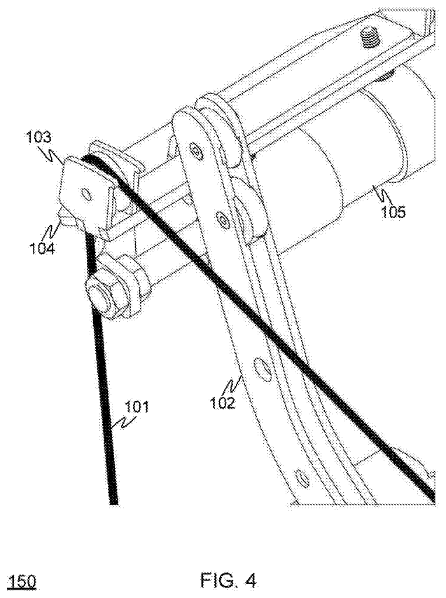

FIG. 4 depicts needle 102 moved upward past lower twine 101 while the lower shifter assembly 150 is actuated (shifted). This results in lower twine 101 remaining on the lower twine shifting guide roller 103 in the same horizontal level as the lower bale surface position 215 while the needle 102 rotates past it and up towards knotter 231. Thus, in FIGS. 3-4 the lower twine shifting guide roller 103 has moved the lower twine 101 out of the needle plane 250 so that it is not caught by the needle 102, thus not sending the lower twine 101 into the knotting mechanism 231.

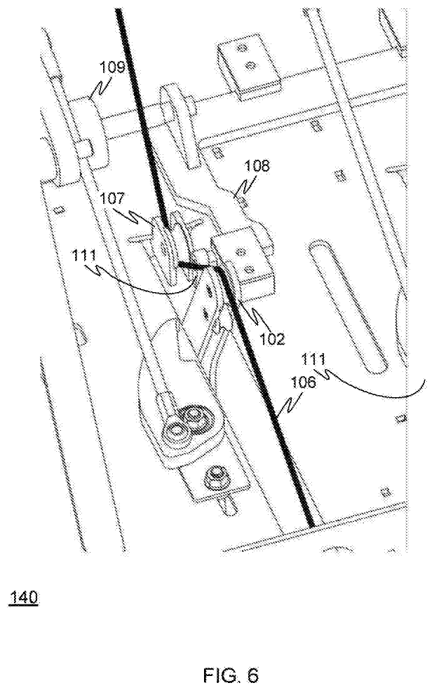

FIGS. 5-8 show the upper twine shifter assembly 140 in four different positions. As a preliminary matter it should be noted that FIGS. 5-8 are simplified views used for illustrative purposes. In practice, by the time the needle 102 pushes upward as in FIG. 6 (with the shifter mechanisms at rest) there would be four strands of twine on needle 102, not one. FIG. 6 shows only the single upper twine 106 in order to explain the function of the upper twine shifter assembly 140.

Turning to FIG. 5, the upper twine shifter assembly 140 is shown in the resting position with the upper actuator cylinder 109 at rest (unshifted) and the upper twine 106 at the upper bale surface position 210, while the needle 102 is positioned below the upper shifter twine guide 107. This allows upper twine 106 to remain in the needle plane 250, ready to be picked up and carried towards knotter 231.

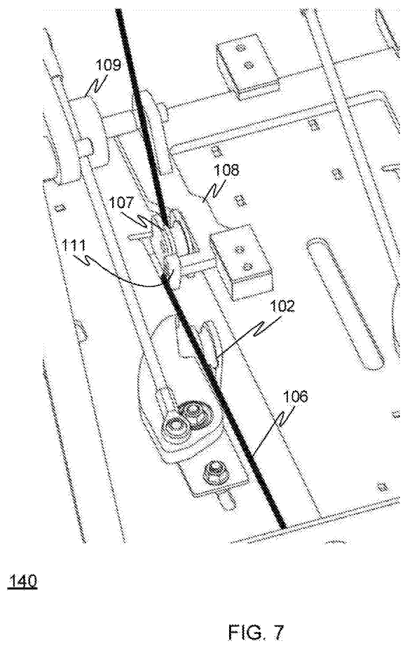

FIG. 6 depicts the upper shifter assembly 140 with the needle 102 moved up past upper twine 106's rest position (up past the upper bale surface position 210). This pushes upper twine 106 upwards while the upper shifter assembly 140 remains in the resting position. One difference between the upper shifter assembly 140 embodiment and the lower shifter assembly 150 embodiment is that the upper twine guide roller 107 remains stationary in needle plane 250 during all phases of knot tying while the lower twine shifting guide roller 103 shifts in and out of needle plane 250. The upper shifter assembly 140 operates through the use of diverter arm 111 which shifts to push the upper twine 106 out of the needle plane 250. This can be seen in FIG. 7.

FIG. 7 depicts the needle 102 below the upper shifter assembly 140, while the upper shifter assembly 140 is actuated. In its actuated (shifted) state the diverter arm 111 shifts to push upper twine 106 out of the needle plane 250 while remaining in the same horizontal plane as the upper bale surface position 210, and thus out of the way of needle 102's path. Diverter arm 111 is connected to upper shifting carriage 108, which in turn is connected to upper actuator cylinder 109. FIGS. 5-8 depict the diverter arm 111 and shifting carriage 108 as two different connected components. But in some embodiments a single component is formed to take the place of these two pieces.

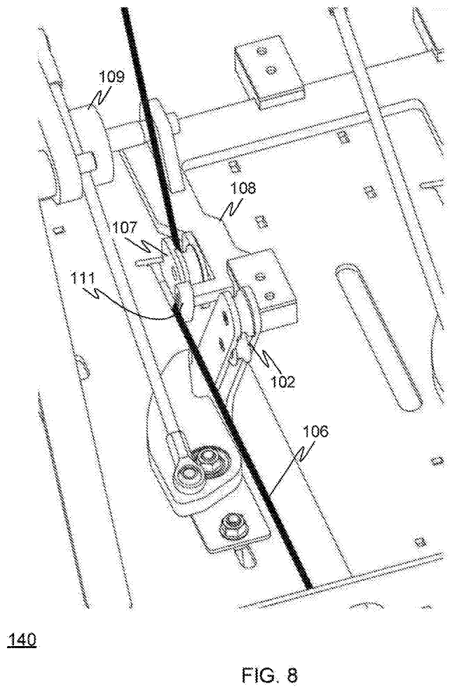

FIG. 8 shows upper twine shifter assembly 140 with the needle 102 having moved upwards past the upper bale surface position 210 while the upper shifter assembly 140 is actuated, pushing upper twine 106 to the side out of the needle plane 250.

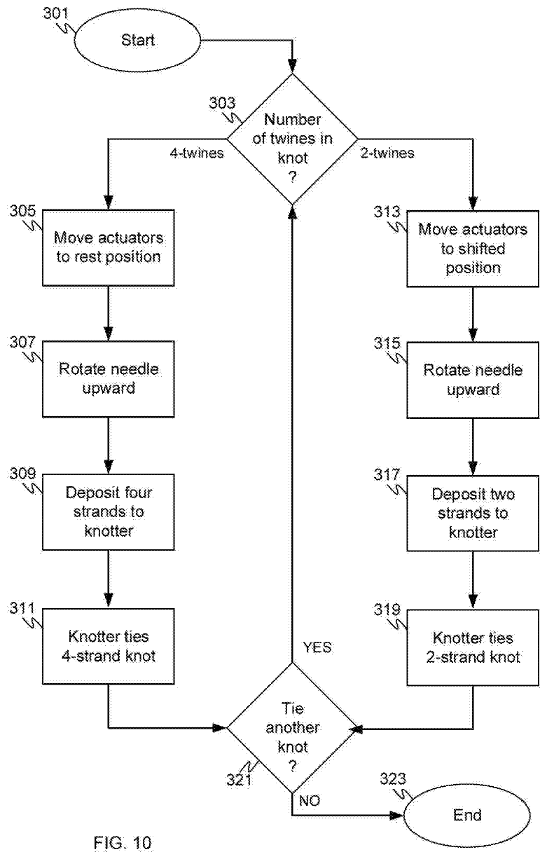

FIG. 10 depicts a flowchart of a method for using various embodiments disclosed herein. The method begins at block 301 and proceeds to block 303 where it is determined whether the knot to be tied is a 4-twine knot or a 2-twine knot. If a 4-twine knot is to be tied the method proceeds from block 303 along the “4-twine” path to block 305.

In block 305 the upper and lower actuators are controllably moved to the rest position (or left in the rest position if that's where they are presently located). This places the upper and lower twines (e.g., twines 106/101 of FIG. 9) within the needle plane, in position to be picked up by the needle. The method then proceeds from block 305 to block 307. In block 307 the needle is moved upward from its lowered position towards the knotter. Since the upper and lower twines (e.g., twines 106/101 of FIG. 9) are in the needle plane they are both deposited on the needle as it moves upward gathering the other two twines (e.g., twine from spindles 901 and 902 of FIG. 9). In block 309 the needle reaches the knotter, providing four strands to it. In block 311 the knotter ties a 4-strand knot with the four strands. The method proceeds to block 321 to determine whether more knots are to be tied.

Back in block 303 if it is determined that a 2-twine knot is to be tied the method proceeds from block 303 along the “2-twine” path to block 313. In block 313 the upper and lower actuators are controllably moved to the shifted position. This places the upper and lower twines (e.g., twines 106/101 of FIG. 9) outside of the needle plane, in position to be passed up by the needle as it moves upward. The method then proceeds from block 313 to block 315. In block 315 the needle is moved upward from its lowered position towards the knotter. Since the upper and lower twines (e.g., twines 106/101 of FIG. 9) are outside the needle plane they both avoid being picked up as the needle moves upward. In block 317 the needle reaches the knotter, providing only two strands to it (e.g., twine from spindles 901 and 902 of FIG. 9). In block 319 the knotter ties a 2-strand knot with the two strands. The method proceeds to block 321 to determine whether more knots are to be tied. If no more knots are to be tied the method proceeds to block 323 and ends.

For ease and accuracy in describing the various embodiments the directional terms “right,” “left,” “up” and “down” are used in this disclosure. These terms refer to the directions right, left, up and down as viewed from the perspective of looking towards the multi-part square baler 100 depicted in FIG. 9. The term “lateral” means from side to side, that is, left to right. Something positioned laterally adjacent to a component is positioned adjacent the component on either the left side or the right side. The term “vertical” is defined by a line extending up from the center of the earth through the object. The “horizontal” direction is orthogonal to the vertical direction.

The needle 102 is described throughout as moving “upward” or “downward” or being in an “upward position”. However, it is clear from the discussion of the needle 102's movement in conjunction with FIG. 9 that the needle 102 does not move in a straight up/down motion. Instead, as explained above the needle 102 rotates about point 973 shown in FIG. 9 so as to rotate in direction 975. As needle 102 rotates its tip (i.e., where its roller guides are located) moves upward or downward-albeit in a circular motion. As needle 102 shown in FIG. 9 rotates clockwise it moves “upward”, as this term is used herein with respect to needle 102. As needle 102 shown in FIG. 9 rotates counter-clockwise (towards its rest position) it moves “downward”, as this term is used herein with respect to needle 102. (It should be noted that the needle 102 cannot rotate clockwise past the knotter 231 and back down the other side.)

The needle 102 is described herein as being “within needle plane 250”. The lower twine shifting roller 103 is also described as being within needle plane 250 in its resting position. However, it is well known that a three-dimensional object cannot fit within a two-dimensional plane—in a mathematical sense, that is. Therefore, the phrase “within needle plane 250” used herein means the needle plane 250 passes through the object—e.g. the needle 102 or the lower twine shifting roller 103 in its resting (non-shifted) position.

The lower actuator cylinder 105 and the upper actuator cylinder 109 are each configured to be in a rest position (or resting position) or in a shifted position. The lower actuator cylinder 105 and the upper actuator cylinder 109 are each capable of being controllably moved between the rest position and the shifted position—that is, they can be controlled (e.g., by increased or decreased flow or pressure of hydraulic fluid) to move between the two positions. It should be noted that the lower actuator cylinder 105 is in its rest position with its cylinder rod withdrawn inward as shown in FIGS. 1-2, and is in its shifted position with its cylinder rod extended outward as shown in FIGS. 3-4. In contrast to this, the upper actuator cylinder 109 is in its rest position with its cylinder rod extended outward as shown in FIGS. 5-6, and is in its shifted position with its cylinder rod withdrawn inward as shown in FIGS. 7-8.

Two parts are “slidably connected”, as this term is used herein, if the two parts are connected in a manner that allows them to slide back and forth relative to each other. For example, the drawers on some steel office desks pull out and push in relative to the desk, but cannot be removed from the desk without releasing a latch. Such desk drawers are “slidably connected” to the desk. Similarly, two parts are considered rotatably connected if one part can rotate relative to the other part. For example, a car wheel is rotatably connected to the car. Two parts are removably connected if they can be taken apart without destroying or significantly damaging either part. Bolts, screws and rivets can be used to removably attach (or removably affix) two parts. Parts that are welded together are not typically considered removably connected (—although it may be possible to removably connect two parts by spot welding them together).

For ease of description, this document refers to a twine disk being part of a hay baler. However, it should be understood that the term “hay” in hay baler is merely a common example of a type of baler. The term “hay baler” as used throughout this disclosure and in the claims may refer to any type of baler that fastens loose object with twine into a bale. A bale is a bundle of hay, cotton, or other materials tightly wrapped and bound with twine. Although the descriptions in this document refers mostly to hay bales for ease of illustration, the various embodiments may be implemented with any number of crops or other materials aside from hay. For example, a twine disk configured for use in a “hay baler” according to the various embodiments may be used to make bales of hay, straw, grass, corn stalks, pine needles, sugar cane mulch, or any other types of plant stems, stalks, shafts, sticks, and/or leaves from any plants known to those of ordinary skill in the art. Moreover, the various embodiments of a twine disk configured for use in a “hay baler” may be implemented with any number of other non-plant materials formed into bales, including for example, paper, lumber, shingles, pipe, tubing, insulation, bricks, tiles or any other material that can be baled for transport or storage, as such materials are known by those of ordinary skill in the art. This document uses the term “twine” to describe the material used to create bales. “Twine” as used herein is defined to include string, rope, cord, wire, strapping, or other long flexible strands that one of ordinary skill in the art considers suitable for use in a baler.

A given line is a “substantially straight-line” if it does not vary by more than +/5% from a straight-line path. The straight-line path used to determine this is the average straight-line path drawn through the distance covered by the given line. The average straight-line path is the straight line that has the smallest average distance between the itself and all adjacent points along the given line (disregarding the +/− signs of the differences—that is, plus and minus differences don't offset each other.) To determine whether the given line is a substantially straight-line, first the average straight-line path is drawn through the distance covered by the given line. Then the average straight-line path is measured to determine 5% of its length, and boundaries are drawn 5% above and below the average straight-line path. If the given line remains within these boundaries it is a “substantially straight-line”. (Note: The beginning and ending points of the given line and the average straight-line path need not necessarily coincide.)

For an object (or shape) to be “vee shaped” as this term is used herein, the object must have two substantially straight-line slanting sidewalls (or edges) that are angle away from each other towards the top by an angle of at least 10 degrees but no greater than 120 degrees. The sidewalls may intersect at the bottom or may be connected by a bottom cross piece that is no greater than one-third the length of either sidewall.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and gist of the invention. The various embodiments included herein were chosen and described in order to best explain the principles of the invention and the practical application, and to enable others of ordinary skill in the art to understand the invention for various embodiments with various modifications as are suited to the particular use contemplated.

Design variations, including changes to the orientation and connection of the various shifter assembly components, their relative size or direction of motion, and other such variations, are considered to be included as part of the various embodiments disclosed herein without departing from the scope and intent of this invention.

What is claimed is:

1. A twine shifter assembly configured for use with a hay baler that includes a needle capable of moving in a needle plane, the twine shifter assembly comprising:
a twine guide, the twine guide being aligned within the needle plane in a resting position and being outside of the needle plane in a shifted position; and
an actuator cylinder affixed to the twine guide, wherein the actuator cylinder is configured to controllably move the twine guide between the resting position and the shifted position;
wherein the twine guide in the resting position holds a strand of twine within the needle plane; and
wherein the twine guide in the shifted position holds the strand of twine outside the needle plane.

2. The twine shifter assembly of claim 1, wherein the twine guide in the resting position holds the strand of twine within the needle plane allowing the needle moving in the needle plane to take the strand of twine to a knotter for tying a 4-twine knot; and

3. The twine shifter assembly of claim 1, wherein the twine guide in the shifted position holds the strand of twine outside the needle plane to avoid being taken by the needle as it moves toward the knotter for tying a 2-twine knot.

4. The twine shifter assembly of claim 1,
wherein the twine guide is a roller guide.

5. The twine shifter assembly of claim 1, further comprising:
a bracket slidably affixed to the actuator cylinder, the twine guide being affixed to the actuator cylinder via the bracket;
wherein the bracket is configured to be slid back and forth by the actuator cylinder to move the twine guide between the resting position and the shifted position.

6. The twine shifter assembly of claim 1, wherein the twine shifter assembly is a lower twine shifter assembly; and
wherein the hay baler further comprises an upper twine shifter assembly.

7. The twine shifter assembly of claim 6, wherein the needle moving upward to the knotter with the lower twine shifter assembly and the upper twine shifter assembly each being in the shifted position results in a 2-twine knot being tied by the knotter.

8. The twine shifter assembly of claim 7, wherein the needle moving upward to the knotter with the lower twine shifter assembly and the upper twine shifter assembly each being in the resting position results in a 4-twine knot being tied by the knotter.

9. A method of producing a twine shifter assembly configured for use with a hay baler that includes a needle capable of moving in a needle plane, the method comprising:
providing a twine guide, the twine guide being aligned within the needle plane in a resting position and being outside of the needle plane in a shifted position; and
providing an actuator cylinder affixed to the twine guide, wherein the actuator cylinder is configured to controllably move the twine guide between the resting position and the shifted position;
wherein the twine guide in the resting position holds a strand of twine within the needle plane; and
wherein the twine guide in the shifted position holds the strand of twine outside the needle plane.

10. The method of claim 9, wherein the twine guide in the resting position holds the strand of twine within the needle plane allowing the needle moving in the needle plane to take the strand of twine to a knotter for tying a 4-twine knot; and

11. The method of claim 9, wherein the twine guide in the shifted position holds the strand of twine outside the needle plane to avoid being taken by the needle as it moves toward the knotter for tying a 2-twine knot.

12. The method of claim 9,
wherein the twine guide is a roller guide.

13. The method of claim 9, further comprising:
providing a bracket and slidably affixing the bracket to the actuator cylinder, the twine guide being affixed to the actuator cylinder via the bracket;
wherein the bracket is configured to be slid back and forth by the actuator cylinder to move the twine guide between the resting position and the shifted position.

14. The method of claim 9, wherein the twine shifter assembly is a lower twine shifter assembly; and
wherein the hay baler further comprises an upper twine shifter assembly.

15. The method of claim 14, wherein the needle moving upward to the knotter with the lower twine shifter assembly and the upper twine shifter assembly each being in the shifted position results in a 2-twine knot being tied by the knotter.

16. The method of claim 15, wherein the needle moving upward to the knotter with the lower twine shifter assembly and the upper twine shifter assembly each being in the resting position results in a 4-twine knot being tied by the knotter
